(19) United States
(12) Patent Application Publication
(10) Pub. No.: US 2026/0245493 A1
(43) Pub. Date: Aug. 20, 2026

(54) ELECTRONIC DEVICE AND METHOD FOR CONTROLLING BRIGHTNESS OF DISPLAY

(71) Applicant: Samsung Electronics Co., Ltd., Suwon-si (KR)

(72) Inventors: Sungyong BANG, Suwon-si (KR); Sangmin LEE, Suwon-si (KR); Jonglin LEE, Suwon-si (KR); Hyunjin NOH, Suwon-si (KR); Jinsoo PARK, Suwon-si (KR); Jongwoo KIM, Suwon-si (KR); Hakryoul KIM, Suwon-si (KR); Mooyoung KIM, Suwon-si (KR)

(21) Appl. No.: 19/641,056

(22) Filed: Apr. 7, 2026

Related U.S. Application Data
(63) Continuation of application No. PCT/KR2024/015427, filed on Oct. 11, 2024.

(30) Foreign Application Priority Data
Oct. 13, 2023 (KR) 10-2023-0137143
Nov. 29, 2023 (KR) 10-2023-0169459

(51) Int. Cl. G09G 3/20

(52) U.S. Cl. CPC G09G 3/2092; G09G 2320/041; G09G 2320/0626; G09G 2330/045; G09G 2354/00; G09G 2360/141; G09G 2360/145

(57) ABSTRACT

An electronic device is provided. The electronic device includes sensor circuitry including at least one temperature sensor and at least one illuminance sensor, a display, memory storing instructions, and at least one processor including processing circuitry, wherein the instructions, when executed by the at least one processor individually or collectively, cause the electronic device to obtain a temperature value of the electronic device by using at least one temperature sensor, obtain an illuminance value detected by using at least one illuminance sensor, based on the obtained temperature value being equal to or greater than a threshold temperature value, obtain a brightness setting value corresponding to the obtained temperature value and the obtained illuminance value from brightness level information stored in the memory, set a brightness control value with the obtained brightness setting value, and based on the set brightness control value, control a brightness of the display.

### CROSS-REFERENCE TO RELATED APPLICATION(S)

This application is a continuation application, claiming priority under 35 U.S.C. § 365(c), of an International application No. PCT/KR2024/015427, filed on Oct. 11, 2024, which is based on and claims the benefit of a Korean patent application number 10-2023-0137143, filed on Oct. 13, 2023, in the Ministry of Intellectual Property (MOIP), and of a Korean patent application number 10-2023-0169459, filed on Nov. 29, 2023, in the Ministry of Intellectual Property (MOIP), the disclosure of each of which is incorporated by reference herein in its entirety.

### BACKGROUND

### 1. Field

The disclosure relates to an electronic device and method for controlling the brightness of a display.

### 2. Description of Related Art

With digital technology advancing, electronic devices come in various types, such as smartphones, tablet personal computers (PCs), or personal digital assistants (PDAs). Electronic devices have been developed to be worn by users so as to enhance portability and user accessibility.

Electronic devices may adjust the brightness of the display to control heat generation when the temperature rises. Electronic devices have been applied such that the brightness of the display is limited to a relatively large brightness value (e.g., a maximum value) at a level determined according to temperature.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device and method for controlling the brightness of a display.

Additional aspects will be set forth in part in the description which follows and, in part, will be apparent from the description, or may be learned by practice of the presented embodiments.

In accordance with an aspect of the disclosure, an electronic device is provided. The electronic device includes sensor circuitry including at least one temperature sensor and at least one illuminance sensor, a display, memory storing instructions, storing instructions, and at least one processor including processing circuitry, and the memory wherein the instructions, when executed by the at least one processor individually or collectively, cause the electronic device to obtain a temperature value of the electronic device by using at least one temperature sensor, obtain an illuminance value detected by using at least one illuminance sensor, based on the obtained temperature value being equal to or greater than a threshold temperature value, obtain a brightness setting value corresponding to the obtained temperature value and the obtained illuminance value from brightness level information stored in the memory, set a brightness control value with the obtained brightness setting value, and based on the set brightness control value, control a brightness of the display.

In accordance with another aspect of the disclosure, a method of operating an electronic device is provided. The method includes obtaining a temperature value of the electronic device using at least one temperature sensor of the electronic device, obtaining an illuminance value detected using at least one illuminance sensor of the electronic device, based on the obtained temperature value being equal to or greater than a threshold temperature value, obtaining a brightness setting value corresponding to the obtained temperature value and the obtained illuminance value from brightness level information stored in memory of the electronic device, setting a brightness control value with the obtained brightness setting value, and based on the set brightness control value, controlling a brightness of a display of the electronic device.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include obtaining a temperature value of the electronic device using at least one temperature sensor of the electronic device, obtaining an illuminance value detected using the at least one illuminance sensor of the electronic device, based on the obtained temperature value being equal to or greater than a threshold temperature value, obtaining a brightness setting value corresponding to the obtained temperature value and the obtained illuminance value from the brightness level information stored in the memory of the electronic device, setting a brightness control value with the obtained brightness setting value, and based on the set brightness control value, controlling the brightness of the display of the electronic device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating an electronic device in a network environment according to an embodiment of the disclosure;

FIG. 2 is a view illustrating an example of a configuration of a software module in an electronic device according to an embodiment of the disclosure;

FIGS. 3A and 3B are views illustrating examples of test results for visibility identification for each illuminance according to various embodiments of the disclosure;

FIG. 4 is a view illustrating an example of control level information according to an embodiment of the disclosure;

FIG. 5 is a view illustrating an example of brightness level information according to an embodiment of the disclosure;

FIG. 6 is a view illustrating an example of brightness level information according to an embodiment of the disclosure;

FIG. 7 is a view illustrating an example of brightness level information according to an embodiment of the disclosure; and

FIG. 8 is a view illustrating an example of an operation method in an electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As used herein, the term “user” may denote a human or another device (e.g., an artificial intelligent electronic device) using the electronic device.

A term such as “~module” in the electronic device 101 described in the disclosure refers to a unit processing at least one function or operation, and the unit may be implemented by hardware, software, or a combination of hardware and software. Although the electronic device 101 is described as “module,” the module may be replaced with a term such as “~circuitry,” “~unit,” or “~device.”

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

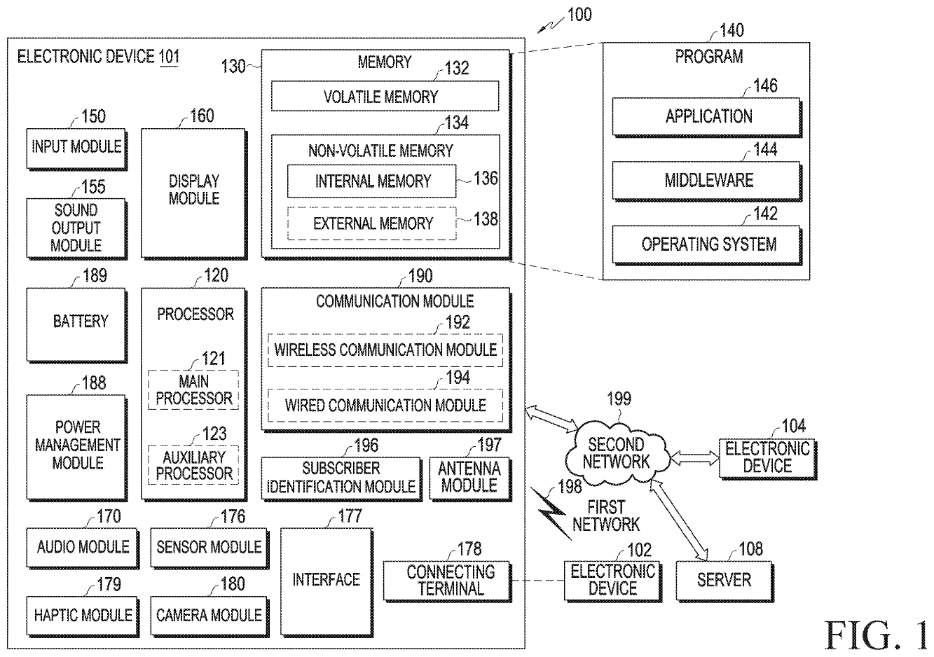

FIG. 1 is a block diagram illustrating an electronic device 101 in a network environment 100, according to an embodiment of the disclosure.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., the program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing recordings. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an external environmental state (e.g., the user's state), and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wiredly) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wiredly) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a fifth generation (5G) network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

An electronic device and an operation method in the electronic device for controlling the brightness of a display according to an embodiment are described with reference to the configuration of the electronic device of FIG. 1. Hereinafter, the term “obtain” described according to an embodiment of the disclosure may be replaced with at least one term among “identify,” “detect,” “receive,” or “calculate,” and the term “identify” may be replaced with at least one term among “determine,” “decide,” or “confirm.”

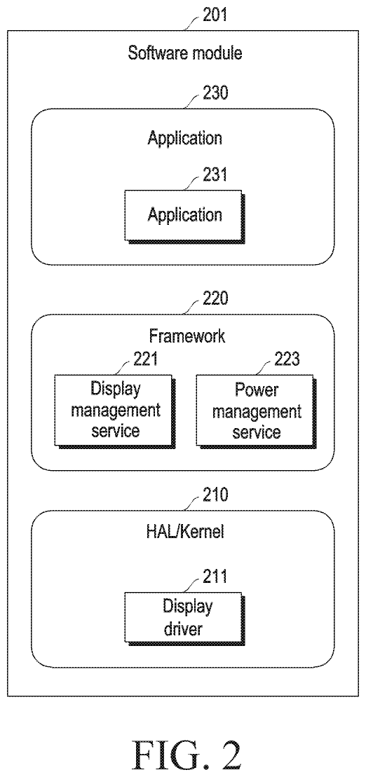

FIG. 2 is a view illustrating an example of a configuration of a software module in an electronic device according to an embodiment of the disclosure.

Referring to FIGS. 1 and 2, an electronic device 101 (e.g., the electronic device 101 of FIG. 1) according to an embodiment may implement a software module 201 (e.g., the program 140 of FIG. 1) for executing brightness control of a display (e.g., the display module 160 of FIG. 1). The memory 130 of the electronic device 101 may store commands (e.g., instructions) for implementing the software module 201 of FIG. 2. The at least one processor 120 may execute instructions stored in the memory 130 to implement the software module 201 illustrated in FIG. 2, and may control hardware (e.g., the sensor module 176, the power management module 188, the display module 160, or other necessary components of FIG. 1) associated with the function of the software module 201.

The software module 201 of the electronic device 101 according to an embodiment may include a kernel 210 (or a hardware abstraction layer (HAL)), a framework 220 (e.g., the middleware 144 of FIG. 1), and an application 230 (e.g., the application 146 of FIG. 1). At least a portion of the software module 201 may be preloaded on the electronic device 101 or may be downloaded from a server (e.g., the server 108).

According to an embodiment, the kernel 210 may be configured to include, e.g., a display driver 211. The kernel 210 may include, e.g., a system resource manager or a device driver, but is not limited thereto and may be configured to further include other modules. The system resource manager may perform control, allocation, or recovery of system resources. The device driver may include, e.g., a camera driver, a Bluetooth driver, a shared memory driver, a USB driver, a keypad driver, a Wi-Fi driver, an audio driver, an inter-process communication (IPC) driver, or other device drivers. According to an embodiment, the kernel 210 is a module provided to access or control HW and may include a hardware abstraction layer (HAL), and may provide an interface to allow an application or service to use the HW. The HAL reads temperature information from temperature sensors and calculates a surface temperature, provides temperature-related information to a registered app or service, and may periodically calculate the surface temperature and transmit the surface temperature to a display management service 221.

According to an embodiment, the kernel 210 is a module directly controlling the HW and may include drivers of various devices, provides a function to directly set the brightness of the display, and may receive a brightness value determined by a power management service 223 and process so that the actual brightness is changed.

According to an embodiment, a framework 220 may include, e.g., the display management service 221 and the power management service 223, and is not limited thereto and may be set to further include other modules (or services). The framework 220 may provide functions commonly required by the application 230, or may provide various functions to the application 230 through an application programming interface (API) (not shown) such that the application 230 may efficiently use limited system resources inside the electronic device 101. According to an embodiment, the display management service 221 may provide a function according to driving of the display. The display management service 221 may provide a function to control the brightness of the display under the control of the processor 120 with a relatively large brightness control value (e.g., a maximum brightness control value) preset based on the temperature value (e.g., a surface temperature value and/or an internal temperature value) of the electronic device 101 to limit the brightness of the display for heat control of the electronic device 101.

According to an embodiment, the display management service 221 may control the brightness of the display considering outdoor visibility. The display management service 221 may manage temperature information, illuminance information, and information related to a control policy (e.g., brightness level information, brightness control information). The display management service 221 may include a heat control module (e.g., intelligent overheat protection) providing a function to lower the temperature of the electronic device 101 by reducing current consumption of hardware modules when heat is generated by an AP, charging, and brightness based on the relatively large brightness control value (e.g., a maximum brightness control value). The heat control module provides a function for relatively large brightness control (e.g., maximum brightness control), and may transmit a control signal requesting brightness control of the display with the relatively large brightness control value (e.g., a maximum brightness control value) corresponding to the detected temperature of the electronic device 101 to the power management service 223 using a table in which a heat control policy (e.g., a brightness control level) according to temperature is defined. The display management service 221 may control the relatively large brightness (e.g., a maximum brightness) of the display using an API provided by the power management service 223.

According to an embodiment, the display management service 221 may be set to execute a first control function (e.g., a brightness control function according to a temperature level or temperature change) or a control function of a high brightness mode (HBM) which is a second control function (e.g., an HBM max control function) according to the relatively large brightness setting value (e.g., a maximum brightness setting value) of the high brightness mode (HBM). According to an embodiment, the display management service 221 may periodically manage an internal temperature and a surface temperature of the electronic device 101 detected to generate a temperature event to modules related to brightness control.

According to an embodiment, the display management service 221 manages a table (e.g., an HBM+ value table) that sets a brightness level of the high brightness mode to be adjusted according to a temperature change amount and/or a temperature level when executing the high brightness mode, and may provide a function to reduce a brightness value determined by illuminance to a level defined in the table (e.g., the HBM+ value table) according to the temperature change amount and the temperature level to increase the HBM maintenance time during HBM operation in a temperature range in which the maximum brightness control function due to heat does not operate.

According to an embodiment, the display management service 221 may include a module for receiving and managing feedback information of the user, may manage feedback data of a range adjustable or inputable by the user, and the feedback data may be managed classified by illuminance value or illuminance level.

According to an embodiment, the display management service 221 may provide a function to identify the brightness setting value of the high brightness mode according to the brightness setting reference set in the electronic device 101 using the brightness level information classified for each of the plurality of brightness setting references, set the identified brightness setting value as the brightness control value, and control the display brightness.

According to an embodiment, the power management service 223 may provide a function to manage a battery or power and provide power information required for operation of the electronic device. The power management service 223 may manage brightness control policies of the display and provide APIs required for brightness control. The power management service 223 may receive an illuminance value detected by the at least one illuminance sensor included in the sensor module 176 and provide a function to transmit the received illuminance value to a module needing the received illuminance value.

According to an embodiment, the power management service 223 manages brightness level information (e.g., a table) that sets a minimum brightness level where visibility is guaranteed for each illuminance, and may provide a function for brightness control of the display using the brightness level information (e.g., a table) that sets the minimum brightness level. The brightness level information may be a test result of a preset number of times determined considering visibility, current consumption, and heat by combining levels that actual users directly experienced and responded that there was no problem.

According to an embodiment, the framework 220 includes intelligent overheat protection defined in XML or display configuration information, and may include resources that may transmit information (e.g., brightness level information (or tables)) needed by the display management service 221 to a module needing the information. According to an embodiment, the framework 220 may include a sensor manager that is a module managing sensors inside the electronic device 101 and manages registration and deregistration so that various sensors such as brightness, illuminance, proximity, and acceleration may be used by a service or application and provides sensor information to registered functions.

According to an embodiment, the framework 220 may include a module forming a combination of various functions of the above-described components. The framework 220 may provide a specified module per type of the operating system in order to provide a differentiated function. The framework 220 may dynamically omit some existing components or add new components.

According to an embodiment, the application 230 may be set to include an application 231 (e.g., a module, a manager, or a program) related to brightness control of the display. The application 230 may include applications according to heat generation control of the electronic device or execution of various functions. The application 230 may include an application received from an external electronic device (e.g., the server 108 or the electronic devices 102 and 104). According to an embodiment, the application 230 may include a preloaded application or a third party application downloadable from a server. According to the illustrated embodiment, the components of the software module 201 and the names of the components may be varied depending on the type of the operating system. According to an embodiment, at least a part of the software module 201 may be implemented in software, firmware, hardware, or in a combination of two or more thereof. At least part of the software module 201 may be implemented (e.g., executed) by e.g., a processor (e.g., an AP). At least a part of the software module 201 may include at least one of, e.g., a module, program, routine, set of instructions, process, or the like for performing at least one function.

Referring to FIGS. 1 and 2, an electronic device (e.g., the electronic device 101 of FIG. 1) according to an embodiment may include a sensor module 176 including at least one temperature sensor and at least one illuminance sensor, a display module 160, memory 130, and at least one processor 120.

According to an embodiment, the processor 120 may periodically detect the temperature of the electronic device 101 and perform heat control based on the detected temperature to reduce current consumption of hardware modules of the electronic device 101 to lower the temperature or prevent the temperature from rising. The processor 120 may control the display brightness so that display brightness above a predetermined level may not be used when the temperature rises for heat control. According to an embodiment, the processor 120 may control the relatively large brightness (e.g., maximum brightness) while maximally guaranteeing visibility of the user by controlling to an optimal brightness level for each illuminance during heat control operation in an outdoor direct sunlight environment.

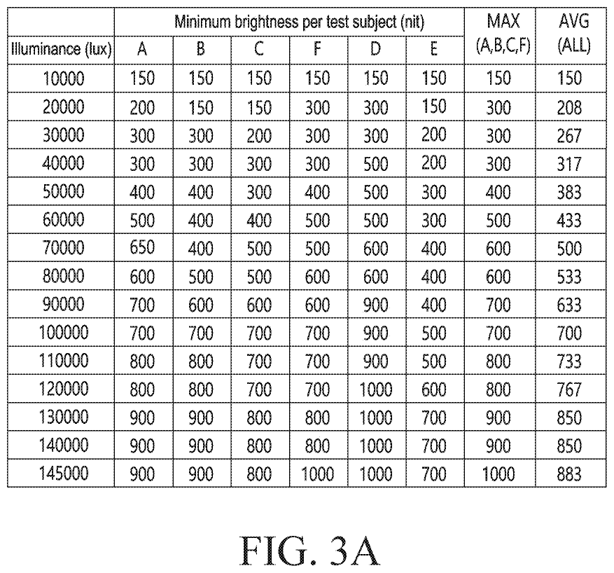

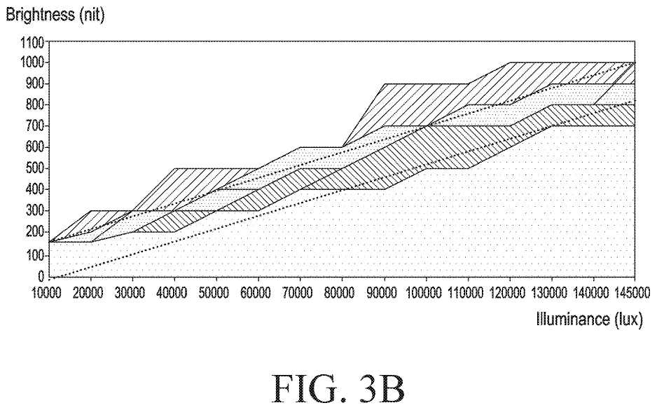

FIGS. 3A and 3B are views illustrating examples of test results for visibility identification for each illuminance according to various embodiments of the disclosure. FIG. 4 is a view illustrating an example of control level information according to an embodiment of the disclosure.

Referring to FIGS. 1, 3A, 3B, and 4, according to various embodiments, the processor 120 may perform a test operation to identify an optimal brightness for securing visibility for each illuminance prior to performing a control operation on the brightness of the display. Here, the test operation may be set in a manufacturing process of the electronic device 101 or set when the user first uses the electronic device 101 or when needed, and may update previously set information through a setting function when needed at the request of the user.

According to an embodiment, to perform the test operation, the processor 120 may perform the test using lighting (e.g., broadcast lighting) in an enclosed space to reduce test deviation. Referring to FIG. 3A, the processor 120 may configure a user group, identify minimum brightness values (nit) visible for each illuminance (lux) for each of users (e.g., users A to E) in the group, and specify the required brightness (e.g., brightness setting values) for each illuminance as a maximum value (max(A, B, C, F)) or an average value (e.g., avg(all)) of the identified minimum brightness values for each illuminance. The users of the user group may be arbitrarily configured, and the more users, the more objective visibility may be obtained. Referring to FIG. 3B, the processor 120 may set the minimum brightness values 301 identified through the test operation and the brightness setting values for each illuminance in the form of a table or a graph, and store the set visibility table and the brightness graph for each illuminance in the memory 130.

According to an embodiment, the processor 120 may limit the brightness where there is no problem in visibility for each illuminance within a specific range when outliers (a person with very low visibility in a bright environment or a person with very good visibility in a dark environment) are excluded by analyzing the set visibility table and the brightness graph for each illuminance. Referring to FIG. 4, the processor 120 may specify a specific illuminance level by analyzing the set visibility table and the brightness graph for each illuminance, specify a brightness setting value which is a brightness where visibility corresponding to the specified illuminance level is secured, and generate a control level table 410 for brightness control. According to an embodiment, as illustrated in FIG. 4, the processor 120 may set the control level table 410 considering all of an increase level of current consumption according to brightness, heat, a safety standard, and visibility. The control level table 410 includes control levels for each illuminance level for performing a brightness control operation for intelligent overheat protection control at or above a threshold temperature (e.g., 40 degrees), and may include a control level added in terms of a safety standard for accident prevention at or above a specific temperature (e.g., 47 degrees) where there is a concern of low-temperature burns. Here, the maximum allowable brightness in the control level table 410 may be specified as a threshold brightness level (e.g., 900 nit) that does not cause a problem with heat in a high-temperature direct sunlight environment in terms of current consumption within the threshold temperature (e.g., 40 degrees). As an example, as illustrated in FIG. 4, the control level at or below the minimum illuminance level (e.g., 30,000 lux) in the control level table 410 may be set to maintain the existing brightness control. The remaining illuminance levels among the illuminance levels may set the control level for each illuminance level for performing the brightness control operation. For example, the control level at or below 70,000 lux is set to the threshold temperature (e.g., 40 degrees) and the brightness setting value (e.g., 255 (500 nit)), the control level at or below 120,000 lux is set to the threshold temperature (e.g., 40 degrees) and the brightness setting value (e.g., 357 (700 nit)), and the control level at or above 120,000 lux may be set to the threshold temperature (e.g., 40 degrees) and the brightness setting value (e.g., 459 (900 nit)). For example, when the brightness control operation due to heat is not performed at or above 30,000 lux, a phenomenon in which current consumption and device temperature increase may occur, and since a difference in actual current consumption and heat becomes large compared to when all brightness of the high brightness mode is allowed, a problem due to battery use and heat may occur.

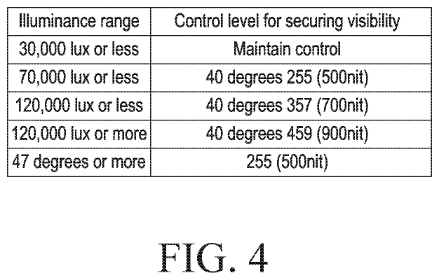

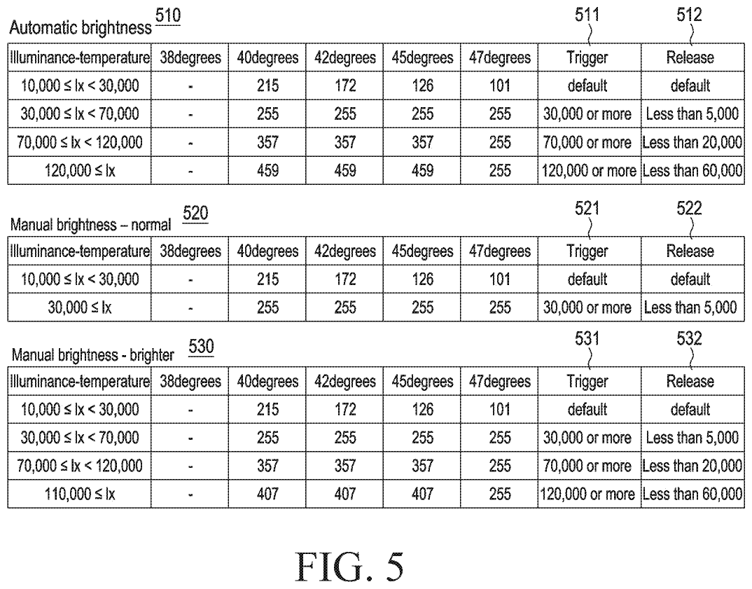

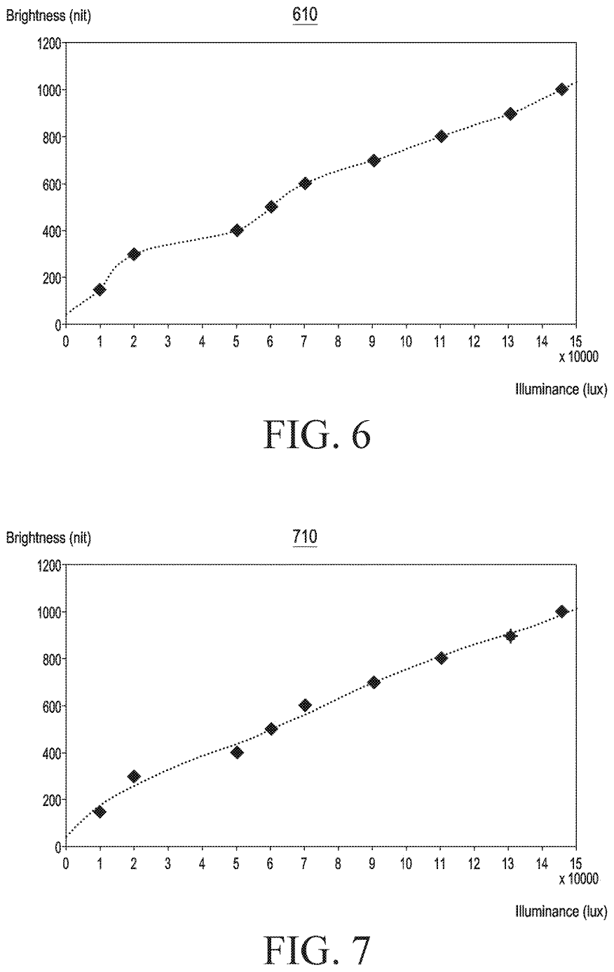

FIG. 5 is a view illustrating an example of brightness level information according to an embodiment of the disclosure. FIGS. 6 and 7 are views illustrating examples of brightness level information according to various embodiments of the disclosure.

Referring to FIGS. 1 and 5, according to an embodiment, the processor 120 may preset brightness level information through a test operation to identify an optimal brightness for securing visibility for each illuminance prior to performing a brightness control operation of the display. Here, the test operation may be set in a manufacturing process of the electronic device 101 or set when the user first uses the electronic device 101 or when needed, and may update previously set brightness level information through a setting function when needed at the request of the user. According to an embodiment, the processor 120 may receive and set or update the brightness level information set through the test operation from an external electronic device (e.g., a server).

According to an embodiment, the processor 120 may set brightness level information 510, 520, and 530 based on an illuminance level and a temperature level obtained (e.g., detected or calculated) for a predetermined time (or a predetermined number of times) through a test according to actual use of the electronic device 101 by the user, and store the set brightness level information 510, 520, and 530 in the memory 130. According to an embodiment, the processor 120 may set the brightness level information 510, 520, and 530 in the form of a table as a minimum brightness level where visibility is guaranteed for each of temperature levels and illuminance levels obtained through the test operation. Without limitation to the form of a table, the brightness level information may be set in the form of a curve (or a graph). According to an embodiment, the processor 120 may set the brightness level information 510, 520, and 530 classified for each of a plurality of brightness setting references (or modes), and may identify (e.g., identify or calculate) brightness setting values corresponding to each of temperature levels and illuminance levels and set the brightness level information 510, 520, and 530 including the identified brightness setting values. Here, the brightness setting value may be a relatively large value (e.g., a maximum value) of the brightness mode (HBM).

According to an embodiment, the processor 120 may set the brightness level information (e.g., first brightness level information 510, second brightness level information 520, and third brightness level information 530) classified for each of the plurality of brightness setting references. The plurality of brightness setting references may include a first brightness setting reference (e.g., an automatic brightness reference) for automatically controlling the brightness of the display according to external illuminance, a second brightness setting reference (e.g., a manual brightness reference) for controlling the brightness of the display by fixing the brightness set by the user, and a third brightness setting reference (e.g., a manual brightness-brighter reference) for controlling the brightness of the display to be brighter than the brightness value set according to the second brightness setting reference. The first brightness level information 510 is brightness level information for the first brightness setting reference, the second brightness level information 520 is brightness level information for the second brightness setting reference, and the third brightness level information 530 may be brightness level information for the third brightness setting reference. Referring to FIG. 5, the first brightness level information 510 may be set classified into a plurality of illuminance levels (e.g., 10,000≤lx<30,000, 30,000≤lx<70,000, 70,000≤lx<120,000, and 120,000≤lx) and temperature values (or temperature levels) (e.g., 40 degrees, 42 degrees, 45 degrees, 47 degrees) in a temperature range (e.g., 40 degrees or higher to less than 47 degrees) for display brightness control. The first brightness level information 510 may include brightness setting values (e.g., 10,000≤lx<30,000: 215, 172, 126, and 101 nit, 30,000≤lx<70,000: 255, 255, 255, and 255 nit, 70,000≤lx<120,000: 357, 357, 357, and 255 nit, 120,000≤lx: 459, 459, 459, and 255 nit) set corresponding to each of the illuminance levels and each of the temperature levels. The second brightness level information 520 may be set classified into a plurality of illuminance levels (e.g., 10,000≤lx<30,000 and 30,000≤lx) and temperature values (or temperature levels) (e.g., 40 degrees, 42 degrees, 45 degrees, 47 degrees) in a temperature range (e.g., 40 degrees or higher to less than 47 degrees) for display brightness control. The second brightness level information 520 may include brightness setting values (e.g., 10,000≤lx<30,000: 215, 172, 126, and 101 nit, 30,000≤lx: 255, 255, 255, and 255 nit) set corresponding to each of the illuminance levels and each of the temperature levels. The third brightness level information 530 may be set classified into a plurality of illuminance levels (e.g., 10,000≤lx<30,000, 30,000≤lx<70,000, 70,000≤lx<110,000, and 110,000≤lx) and temperature values (or temperature levels) (e.g., 40 degrees, 42 degrees, 45 degrees, 47 degrees) in a temperature range (e.g., 40 degrees or higher to less than 47 degrees) for display brightness control. The third brightness level information 530 may include brightness setting values (e.g., 10,000≤lx<30,000: 215, 172, 126, and 101 nit, 30,000≤lx<70,000: 255, 255, 255, and 255 nit, 70,000≤lx<110,000: 357, 357, 357, and 255 nit, 110,000≤lx: 407, 407, 407, and 255 nit) set corresponding to each of the illuminance levels and each of the temperature levels.

According to an embodiment, the processor 120 may set a first illuminance condition 511, 521, 531 for starting (trigger) control of the brightness of the display and a second illuminance condition 512, 522, 532 for ending (release) control of the brightness of the display, and set and store the brightness level information (e.g., the first brightness level information 510, the second brightness level information 520, and the third brightness level information 530) classified for each of the plurality of brightness setting references including the set first illuminance condition 511, 521, 531 and the set second illuminance condition 512, 522, 532. The interval between the first illuminance condition 511, 521, 531 and the second illuminance condition 512, 522, 532 may be set to a level where the brightness setting value does not change frequently and the brightness value does not change with a small tilt change of the device. As illustrated in FIG. 5, the first brightness level information 510 may include the first illuminance condition 511 set for each illuminance level (e.g., 10,000≤lx<30,000: default, 30,000≤lx<70,000: 30,000 lux or higher, 70,000≤lx<120,000: 70,000 lux or higher, and 120,000≤lx: 120,000 lux or higher). The first brightness level information 510 may include the second illuminance condition 512 set for each illuminance level (e.g., 10,000≤lx<30,000: default, 30,000≤lx<70,000: less than 5,000 lux, 70,000≤lx<120,000: less than 20,000 lux, and 120,000≤lx: less than 60,000 lux). The second brightness level information 520 may include the first illuminance condition 521 set for each illuminance level (e.g., 10,000≤lx<30,000: default, 30,000≤lx: 30,000 lux or higher). The second brightness level information 520 may include the second illuminance condition 522 set for each illuminance level (e.g., 10,000≤lx<30,000: default, 30,000≤lx: less than 5,000 lux). The third brightness level information 530 may include the first illuminance condition 531 set for each illuminance level (e.g., 10,000≤lx<30,000: default, 30,000≤lx<70,000: 30,000 lux or higher, 70,000≤lx<110,000: 70,000 lux or higher, and 110,000≤lx: 110,000 lux or higher). The third brightness level information 530 may include the second illuminance condition 532 set for each illuminance level (e.g., 10,000≤lx<30,000: default, 30,000≤lx<70,000: less than 5,000 lux, 70,000≤lx<110,000: less than 20,000 lux, and 110,000≤lx: less than 60,000 lux).

According to an embodiment, the processor 120 may use the set brightness level information 510, 520, and 530 when performing a display brightness control operation for heat control in a specific temperature range (e.g., 40 degrees to 47 degrees).

Referring to FIGS. 1, 6, and 7, according to various embodiments, the processor 120 may obtain brightness values where average visibility is secured for each illuminance using a method of calculating an optimal brightness for each illuminance from a test result obtained through the test operation, and set brightness level information 610 in the form of a curve (or a graph) based on the obtained brightness values. According to an embodiment, the processor 120 may obtain an optimal curve for the obtained brightness values (e.g., using a spline method or a polynomial regression method) and set an optimal brightness setting value (e.g., an HBM max value) corresponding to all specified illuminance values. The processor 120 may use the set brightness level information 610 and 710 in the form of a curve (or a graph) when performing a display brightness control operation for heat control in a specific temperature range (e.g., 40 degrees to 47 degrees).

According to an embodiment, the processor 120 may periodically detect the temperature of the electronic device 101 using the at least one temperature sensor. The processor 120 may obtain periodically detected temperature values, and based on the obtained temperature values being equal to or greater than the threshold temperature value (e.g., 40 degrees), perform a display brightness control operation for heat control.

According to an embodiment, based on the obtained temperature values being equal to or greater than the threshold temperature value (e.g., 40 degrees), the processor 120 may obtain an illuminance value detected using the at least one illuminance sensor. Here, the detected illuminance value may be an average value or a maximum value of illuminance values detected for a specified time.

According to an embodiment, the processor 120 may obtain (e.g., load, recognize, identify, or confirm) a brightness setting value corresponding to the obtained temperature value and the obtained illuminance value from the brightness level information (e.g., a brightness level table (HBM max table) 510, 520, and 530 or curves 610 and 710) preset and stored in the memory 130, and set a brightness control value (e.g., a maximum brightness control value) for controlling the brightness of the display with the identified brightness setting value. The processor 120 may change the brightness control value previously set in the display to the identified brightness setting value based on a change in the temperature value and the illuminance value. According to an embodiment, the processor 120 may control the brightness of the display based on the set brightness control value.

According to an embodiment, when performing a display brightness control operation, the processor 120 may identify the brightness setting reference set for the display among the plurality of brightness setting references, and obtain the brightness setting value from the brightness level information corresponding to the identified brightness setting reference based on the obtained illuminance value and the obtained temperature value. As an example, the processor 120 may obtain a temperature value detected using the at least one temperature sensor in real-time or an average temperature value of temperature values obtained for a predetermined time (e.g., 1.5 seconds) and, when the obtained temperature value is included in the temperature range (e.g., 40 degrees to 47 degrees) for display brightness control, identify the brightness setting reference set for the display (e.g., the display module 160 of FIG. 1) and obtain an illuminance value detected using the at least one illuminance sensor or an average illuminance value of illuminance values obtained for a predetermined time (e.g., 1.5 seconds). When the identified brightness setting reference is the first brightness setting reference indicating automatic brightness, the processor 120 may identify a brightness setting value (e.g., 357 nit) corresponding to the obtained illuminance value (e.g., 70,000 lux or higher) and corresponding to the obtained temperature value (e.g., 40 degrees or a value of 40 degrees or higher to 42 degrees or lower) from the prestored first brightness level information 510. The processor 120 may set (e.g., specify or change) a relatively large brightness control value (e.g., 600 nit) with the identified brightness setting value (e.g., 357 nit), and control the display brightness with the set relatively large brightness control value (e.g., 357 nit).

According to an embodiment, when the obtained illuminance value satisfies the first illuminance condition 511, 521, or 531 set in the brightness level information 510, 520, or 530, the processor 120 may start control of the brightness of the display and, when the obtained illuminance value satisfies the second illuminance condition 512, 522, or 532 set in the brightness level information 510, 520, or 530, end the control of the brightness of the display.

According to an embodiment, the processor 120 may display a menu for receiving feedback information related to illuminance from the user on the display (e.g., a setting screen for brightness control displayed on the display, a partial area (e.g., a notification bar display area) of a home screen, or a setting screen for controlling functions of the electronic device). Here, the menu may be displayed in the form of a bar that may change or adjust an illuminance value, and is not limited thereto and may be displayed in other forms that may change or adjust an illuminance value. According to an embodiment, the processor 120 may accumulate and store the number of times the user lowers or lowers and raises the brightness in a specific illuminance and brightness circumstance, and then calculate and store a +/− alpha value for the current brightness control value for each specific illuminance or illuminance level. As an example, the menu may include +/− buttons or another alpha brightness bar that may be set brighter or darker.

According to an embodiment, the processor 120 may receive feedback information according to a user input using the menu displayed on the display, and may obtain a brightness setting value from the brightness level information by applying the received feedback information. In this case, when a previously obtained setting value is present, the processor 120 may set or change the previously obtained setting value to the brightness setting value obtained by the feedback information. The processor 120 may set or change the brightness control value (maximum brightness value) set for the display with the obtained brightness setting value. When the processor 120 receives the user feedback information, the processor 120 may identify the illuminance value included in the feedback information and obtain the brightness setting value corresponding to the identified illuminance value from the second brightness level information 520 or the third brightness level information 530. As an example, when the identified brightness setting reference is the second brightness setting reference indicating manual brightness, the processor 120 may identify whether user feedback information is received. When the user feedback information is received, the processor 120 may obtain a brightness setting value (e.g., 255 nit) corresponding to the illuminance level (e.g., 30,000≤lx) of the second brightness level information 520 including the illuminance value (e.g., 30,000 lux or higher) included in the received feedback information and corresponding to the obtained temperature value (e.g., 40 degrees or a value of 40 degrees or higher to 42 degrees or lower), set (e.g., specify or change) the brightness control value with the obtained brightness setting value, and control the display brightness with the set brightness control value. As another example, when the identified brightness setting reference is the third brightness setting reference indicating manual brightness, the processor 120 may identify whether user feedback information is received. When the user feedback information is received, the processor 120 may obtain a brightness setting value (e.g., 357 nit) corresponding to the illuminance level (e.g., 70,000≤lx<110,000) of the third brightness level information 530 including the illuminance value (e.g., 70,000 lux or higher) included in the received feedback information and corresponding to the obtained temperature value (e.g., 40 degrees or a value of 40 degrees or higher to 42 degrees or lower), set the brightness control value with the obtained brightness setting value, and control the display brightness with the set brightness control value.

According to an embodiment, when there is a previously set brightness control value in the display, the processor 120 may compare the previously set brightness control value with the obtained brightness setting value and, when the values are different, change the previously set brightness control value to the obtained brightness setting value since the brightness control value needs to be changed according to the temperature change or the illuminance change. When the previously set brightness control value and the obtained brightness setting value are the same, the processor 120 may identify that the temperature change or the illuminance change has not occurred and maintain the previously set brightness control value as is or set the obtained brightness setting value.

According to an embodiment, based on the obtained temperature value being less than the threshold temperature value, the processor 120 may identify a temperature change amount of temperature values obtained for a predetermined time (e.g., 30 seconds), and control the brightness of the display with the brightness control value obtained based on the identified temperature change amount. The processor 120 may obtain the relatively large brightness control value from a brightness level control table (e.g., an HBM+ value table) set based on the temperature change amount.

According to an embodiment, when the obtained temperature value is equal to or greater than the threshold temperature value (e.g., 40 degrees or higher) and the brightness setting value of the high brightness mode is not present, the processor 120 may control the brightness of the display with the relatively large brightness control value (e.g., a maximum brightness control value) obtained based on the surface temperature of the electronic device 101. The processor 120 may obtain the relatively large brightness control value from a brightness level control table set based on the surface temperature.

According to an embodiment, when controlling the brightness of the display, the processor 120 may obtain the current brightness value of the display and/or the temperature value (e.g., a surface temperature and/or an internal temperature value) of the electronic device 101, and control the brightness of the display with the set brightness control value (e.g., a maximum brightness control value) based on the obtained current brightness value and/or temperature value.

According to an embodiment, when the set brightness control value is less than the current brightness value, the processor 120 may change the brightness of the display to the set brightness control value and, when the set brightness control value is greater than or equal to the current brightness value, maintain the current brightness of the display without changing the brightness of the display.

According to an embodiment, when the temperature value is greater than or equal to the reference temperature level, the processor 120 may change the brightness of the display to the set brightness control value and, when the temperature value is less than the reference temperature level, maintain the current brightness of the display without changing the brightness of the display.

As described above, in an embodiment, main components of the electronic device have been described through the electronic device 101 of FIG. 1. However, in various embodiments, not all of the components illustrated through FIG. 1 are essential components, and the electronic device 101 may be implemented by more components than the illustrated components or may be implemented by fewer components than the illustrated components. Further, the positions of the main components of the electronic device 101 described above through FIG. 1 may be changed according to various embodiments.

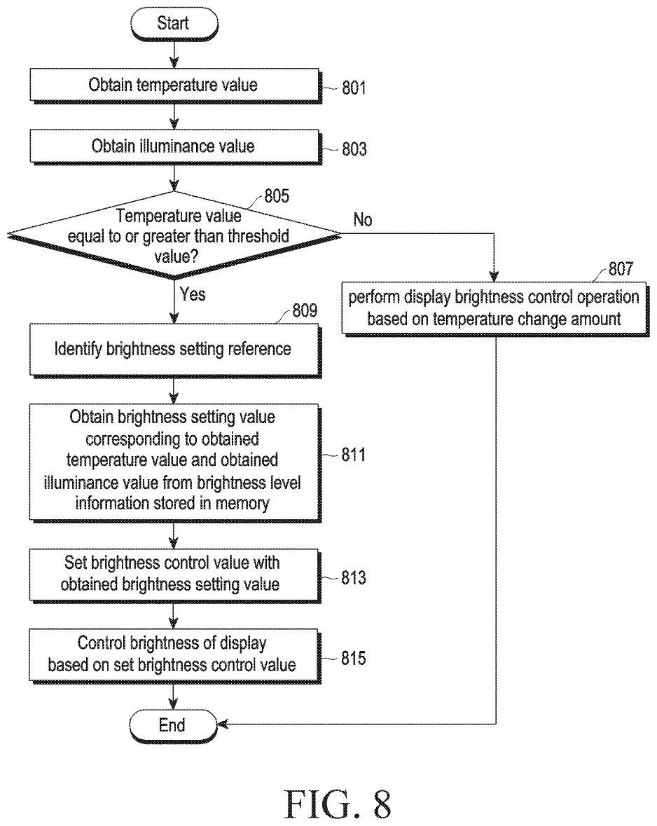

FIG. 8 is a view illustrating an example of an operation method in an electronic device according to an embodiment of the disclosure. In the following embodiment, each operation may be performed sequentially, but is not necessarily performed sequentially. For example, the order of each operation may be changed, and at least two operations may be performed in parallel or other operations may be added.

Referring to FIG. 8, an electronic device (e.g., the electronic device 101 of FIG. 1) according to an embodiment may obtain, in operation 801, a temperature value detected by the at least one temperature sensor (e.g., the sensor module 176 of FIG. 1). The obtained temperature value may be a temperature value detected in real-time or periodically or an average temperature value of temperature values detected for a predetermined time (e.g., 1.5 seconds).

In operation 803, the electronic device may obtain an illuminance value detected by the at least one illuminance sensor (e.g., the sensor module 176 of FIG. 1). The obtained illuminance value may be an illuminance value detected in real-time or periodically or an average illuminance value (or illuminance level) of illuminance values detected for a predetermined time (e.g., 1.5 seconds).

In operation 805, the electronic device may identify whether the obtained temperature value is greater than or equal to a threshold. As an identification result, when the obtained temperature value is greater than or equal to the threshold, the electronic device may perform operation 809 and, when the obtained temperature value is less than the threshold, the electronic device may perform operation 807.

In operation 807 (operation 805—NO), based on the obtained temperature value being less than the threshold temperature value, the electronic device may perform a display brightness control operation based on a temperature change amount. The electronic device may identify a temperature change amount of temperature values obtained for a predetermined time (e.g., 30 seconds) and control the brightness of the display (e.g., the display module 160 of FIG. 1) with the brightness control value obtained based on the identified temperature change amount. The electronic device may obtain the relatively large brightness control value from a brightness level control table (e.g., an HBM+ value table) set based on the temperature change amount.

In operation 809 (operation 805—YES), based on the obtained temperature value being greater than or equal to the threshold temperature value, the electronic device may identify the brightness setting reference.

In operation 811, the electronic device may obtain a brightness setting value corresponding to the obtained temperature value and the obtained illuminance value from the brightness level information (e.g., the first brightness level information 510, the second brightness level information 520, or the third brightness level information 530 of FIG. 5) stored in memory based on the identified brightness setting reference and store the obtained brightness setting value as the brightness setting value (e.g., HBM max value) of the high brightness mode in the memory 130. The brightness level information may be brightness level information corresponding to the identified brightness setting reference.

In operation 813, the electronic device may set the brightness control value for controlling the display brightness with the obtained brightness setting value (e.g., HBM max value). When there is a previously set brightness control value in the display, the electronic device may compare the previously set brightness control value with the obtained brightness setting value and, when the values are different, change the previously set brightness control value to the obtained brightness setting value since the brightness control value needs to be changed according to the temperature change or the illuminance change. When the previously set brightness control value and the obtained brightness setting value are the same, the electronic device may identify that the temperature change or the illuminance change has not occurred and maintain the previously set brightness control value as is or set the obtained brightness setting value.

In operation 815, the electronic device may control the brightness of the display based on the set brightness control value. According to an embodiment, when the set brightness control value is less than the current brightness value of the display, the electronic device may change the brightness of the display to the set brightness control value and, when the set brightness control value is greater than or equal to the current brightness value of the display, maintain the current brightness of the display without changing the brightness of the display. According to an embodiment, when the temperature value of the electronic device is greater than or equal to the reference temperature level, the electronic device may change the brightness of the display to the set brightness control value and, when the temperature value of the electronic device is less than the reference temperature level, maintain the current brightness of the display without changing the brightness of the display.

In the above-described method of operating, when performing operation 813, the electronic device may identify whether user feedback information is received and, when the user feedback information is received, identify (or obtain) a brightness setting value corresponding to the illuminance value or illuminance level included in the received feedback information and set the brightness control value with the identified brightness setting value. The identified brightness setting value is a relatively large brightness setting value and may be stored in memory as the brightness setting value (HBM max value) (e.g., a maximum brightness setting value) of the high brightness mode.

After the above-described operation 803 or when performing an operation of obtaining a brightness setting value from the brightness level information, an operation of identifying whether the brightness setting value of the high brightness mode is present may be performed. When the brightness setting value (e.g., HBM max value) of the high brightness mode is not present, the electronic device may perform a display brightness control operation based on the surface temperature of the electronic device. The electronic device may control the brightness of the display with the relatively large brightness control value (e.g., a maximum brightness control value) obtained based on the surface temperature. The electronic device may obtain the relatively large brightness control value from a brightness level control table set based on the surface temperature.

According to an embodiment, an electronic device (e.g., the electronic device 101 of FIG. 1) may include sensor circuitry (e.g., the sensor module 176 of FIG. 1) including at least one temperature sensor and at least one illuminance sensor, a display (e.g., the display module 160 of FIG. 1), memory (e.g., the memory 130 of FIG. 1) storing instructions, and at least one processor (e.g., the processor 120 of FIG. 1) including processing circuitry.

According to an embodiment, the instructions, when executed by the at least one processor individually or collectively, may cause the electronic device to obtain a temperature value of the electronic device using the at least one temperature sensor.

According to an embodiment, the instructions, when executed by the at least one processor individually or collectively, may cause the electronic device to obtain an illuminance value detected using the at least one illuminance sensor.

According to an embodiment, the instructions, when executed by the at least one processor individually or collectively, may cause the electronic device to, based on the obtained temperature value being equal to or greater than a threshold temperature value, obtain a brightness setting value corresponding to the obtained temperature value and the obtained illuminance value from the brightness level information stored in the memory.

According to an embodiment, the instructions, when executed by the at least one processor individually or collectively, may cause the electronic device to set a brightness control value with the obtained brightness setting value.

According to an embodiment, the instructions, when executed by the at least one processor individually or collectively, may cause the electronic device to, based on the set brightness control value, control the brightness of the display.

According to an embodiment, the brightness level information may be stored in the memory in the form of a table or a curve which includes brightness setting values set as a minimum brightness level that guarantees visibility for each of temperature levels and illuminance levels obtained through prior testing performed a specified number of times.

According to an embodiment, the obtained brightness setting value is a value for identifying whether to change a previously set brightness control value based on a temperature change or illuminance change, and the brightness control value may be set to a value less than or equal to a brightness level specified based on the temperature value of the electronic device to limit the brightness of the display.

According to an embodiment, the instructions, when executed by the at least one processor individually or collectively, may cause the electronic device to, based on the obtained brightness setting value being different from the previously set brightness control value, identify that the temperature change or the illuminance change occurs and set the brightness control value by changing the previously set brightness control value to the obtained brightness setting value, and based on the obtained brightness setting value being the same as the previously set brightness control value, identify that the temperature change or the illuminance change has not occurred and set the brightness control value by maintaining the previously set brightness control value which is the same as the obtained brightness setting value.

According to an embodiment, the brightness level information is set classified for each of a plurality of brightness setting references (or modes), and the brightness level information classified for each of the plurality of brightness setting references may include, respectively, a first illuminance condition for starting control of the brightness of the display and a second illuminance condition for ending control of the brightness of the display.

According to an embodiment, the plurality of brightness setting references may include a first brightness setting reference for automatically controlling the brightness of the display according to external illuminance, a second brightness setting reference for controlling the brightness of the display by fixing the brightness set by the user, and a third brightness setting reference for controlling the brightness of the display to be brighter than the brightness value set according to the second brightness setting reference.

According to an embodiment, the instructions, when executed by the at least one processor individually or collectively, may cause the electronic device to, based on the set brightness control value being less than a current brightness value of the display or the temperature value of the electronic device being greater than or equal to a reference temperature level, change the brightness of the display to the set brightness control value, and based on the set brightness control value being greater than or equal to the current brightness value or the temperature value being less than the reference temperature level, maintain a current brightness of the display without changing the brightness of the display.

According to an embodiment, the instructions, when executed by the at least one processor individually or collectively, may cause the electronic device to identify a brightness setting reference set for the display among the plurality of brightness setting references, and based on the obtained illuminance value and the obtained temperature value, obtain a brightness setting value from brightness level information corresponding to the identified brightness setting reference.

According to an embodiment, the instructions, when executed by the at least one processor individually or collectively, may cause the electronic device to, when the obtained illuminance value satisfies the first illuminance condition, start control of the brightness of the display and, when the obtained illuminance value satisfies the second illuminance condition, end the control of the brightness of the display.

According to an embodiment, the instructions, when executed by the at least one processor individually or collectively, may cause the electronic device to display, on the display, a menu for receiving feedback information related to illuminance from the user and, when receiving the feedback information using the menu, obtain a brightness setting value by applying the feedback information.

According to an embodiment, the instructions, when executed by the at least one processor individually or collectively, may cause the electronic device to, when the obtained temperature value is greater than or equal to the threshold temperature value and the brightness setting value is not present, control the brightness of the display with a brightness control value obtained based on a surface temperature of the electronic device.

According to an embodiment, the instructions, when executed by the at least one processor individually or collectively, may cause the electronic device to, based on the obtained temperature value being less than the threshold temperature value, identify a temperature change amount of temperature values obtained for a predetermined time, and control the brightness of the display with a brightness control value obtained based on the identified temperature change amount.

According to an embodiment, a method of operating an electronic device (e.g., the electronic device 101 of FIG. 1) may include obtaining a temperature value of the electronic device using the at least one temperature sensor of the electronic device. According to an embodiment, the method may include obtaining an illuminance value detected using the at least one illuminance sensor of the electronic device. According to an embodiment, the method may include, based on the obtained temperature value being equal to or greater than a threshold temperature value, obtaining a brightness setting value corresponding to the obtained temperature value and the obtained illuminance value from the brightness level information stored in the memory (e.g., the memory 130 of FIG. 1) of the electronic device. According to an embodiment, the method may include setting a brightness control value with the obtained brightness setting value. According to an embodiment, the method may include, based on the set brightness control value, controlling the brightness of the display (e.g., the display module 160 of FIG. 1) of the electronic device.

According to an embodiment, the brightness level information may be stored in the memory in the form of a table or a curve which includes brightness setting values set as a minimum brightness level that guarantees visibility for each of temperature levels and illuminance levels obtained through prior testing performed a specified number of times.

According to an embodiment, the obtained brightness setting value is a value for identifying whether to change a previously set brightness control value based on a temperature change or illuminance change, and the brightness control value may be set to a value less than or equal to a brightness level specified based on the temperature value of the electronic device to limit the brightness of the display.

According to an embodiment, the setting the brightness control value may include, based on the obtained brightness setting value being different from the previously set brightness control value, identifying that the temperature change or the illuminance change occurs and changing the previously set brightness control value to the obtained brightness setting value, and based on the obtained brightness setting value being the same as the previously set brightness control value, identifying that the temperature change or the illuminance change has not occurred and maintaining the previously set brightness control value which is the same as the obtained brightness setting value. According to an embodiment, the brightness level information is set classified for each of a plurality of brightness setting references, and the brightness level information classified for each of the plurality of brightness setting references may include, respectively, a first illuminance condition for starting control of the brightness of the display and a second illuminance condition for ending control of the brightness of the display.

According to an embodiment, the plurality of brightness setting references may include a first brightness setting reference for automatically controlling the brightness of the display according to external illuminance, a second brightness setting reference for controlling the brightness of the display by fixing the brightness set by the user, and a third brightness setting reference for controlling the brightness of the display to be brighter than the brightness value set according to the second brightness setting reference.

According to an embodiment, the controlling the brightness of the display of the electronic device may include, based on the set brightness control value being less than a current brightness value of the display or the temperature value of the electronic device being greater than or equal to a reference temperature level, changing the brightness of the display to the set brightness control value; and based on the set brightness control value being greater than or equal to the current brightness value or the temperature value being less than the reference temperature level, maintaining a current brightness of the display without changing the brightness of the display.

According to an embodiment, the method may further include identifying a brightness setting reference set for the display among the plurality of brightness setting references.

According to an embodiment, the obtaining the brightness setting value may include, based on the obtained illuminance value and the obtained temperature value, obtaining a brightness setting value from brightness level information corresponding to the identified brightness setting reference.

According to an embodiment, the method may further include, when the obtained illuminance value satisfies the first illuminance condition, starting control of the brightness of the display and, when the obtained illuminance value satisfies the second illuminance condition, ending the control of the brightness of the display.

According to an embodiment, the method may further include displaying, on the display, a menu for receiving feedback information related to illuminance from the user and, when receiving the feedback information using the menu, obtaining a brightness setting value by applying the feedback information.

According to an embodiment, the method may further include, when the obtained temperature value is greater than or equal to the threshold temperature value and the brightness setting value is not present, controlling the brightness of the display with a brightness control value obtained based on a surface temperature of the electronic device.

According to an embodiment, the method may further include, based on the obtained temperature value being less than the threshold temperature value, identifying a temperature change amount of temperature values obtained for a predetermined time, and controlling the brightness of the display with a brightness control value obtained based on the identified temperature change amount.

According to an embodiment, in a non-transitory storage medium storing a program, the program, when executed by a processor (e.g., the processor 120 of FIG. 1) of an electronic device (e.g., the electronic device 101 of FIG. 1), may include instructions that cause the electronic device to execute an operation of obtaining a temperature value of the electronic device using the at least one temperature sensor of the electronic device, an operation of obtaining an illuminance value detected using the at least one illuminance sensor of the electronic device, an operation of, based on the obtained temperature value being equal to or greater than a threshold temperature value, obtaining a brightness setting value corresponding to the obtained temperature value and the obtained illuminance value from the brightness level information stored in the memory (e.g., the memory 130 of FIG. 1) of the electronic device, an operation of setting a brightness control value with the obtained brightness setting value, and an operation of, based on the set brightness control value, controlling the brightness of the display (e.g., the display module 160 of FIG. 1) of the electronic device.

The electronic device according to an embodiment of the disclosure may perform heat control based on a minimum brightness value that may maximally guarantee visibility in a circumstance where maximum brightness needs to be controlled as heat increases due to a temperature rise of the electronic device caused by direct sunlight in an outdoor environment. Accordingly, the electronic device according to an embodiment of the disclosure may minimize heat rise while enhancing visibility problems caused by brightness control, and may reduce inconvenience for the user in viewing the display screen in an outdoor environment. Other various effects may be provided directly or indirectly in the disclosure. Effects obtainable from the disclosure are not limited to the above-mentioned effects, and other effects not mentioned may be apparent to one of ordinary skill in the art from the following description.

The embodiments disclosed herein are proposed for description and understanding of the disclosed technology and does not limit the scope of the disclosure. Accordingly, the scope of the disclosure should be interpreted as including all changes or various embodiments based on the technical spirit of the disclosure.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
sensor circuitry including at least one temperature sensor and at least one illuminance sensor;
a display;
memory storing instructions; and
at least one processor including processing circuitry;
wherein the instructions, when executed by the at least one processor individually or collectively, cause the electronic device to:
obtain a temperature value of the electronic device using the at least one temperature sensor, obtain an illuminance value detected using the at least one illuminance sensor,
based on the obtained temperature value being equal to or greater than a threshold temperature value, obtain a brightness setting value corresponding to the obtained temperature value and the obtained illuminance value from brightness level information stored in the memory,
set a brightness control value with the obtained brightness setting value; and
based on the set brightness control value, control a brightness of the display.

2. The electronic device of claim 1,
wherein the brightness level information is stored in the memory in a form of a table or a curve which includes a plurality of predetermined brightness setting values that correspond to a minimum brightness level that guarantees visibility for each of temperature levels and illuminance levels obtained through prior testing performed a specified number of times,
wherein the obtained brightness setting value is a value for identifying whether to change a previously set brightness control value based on a temperature change or illuminance change,
wherein the set brightness control value is a value less than or equal to a brightness level specified based on the temperature value of the electronic device to limit the brightness of the display, and
wherein the instructions, when executed by the at least one processor individually or collectively, cause the electronic device to:
based on the obtained brightness setting value being different from the previously set brightness control value, identify that the temperature change or the illuminance change has occurred, and set the brightness control value by changing the previously set brightness control value to the obtained brightness setting value, and
based on the obtained brightness setting value being the same as the previously set brightness control value, identify that the temperature change or the illuminance change has not occurred, and set the brightness control value by maintaining the previously set brightness control value which is the same as the obtained brightness setting value.

3. The electronic device of claim 1,
wherein the brightness level information is classified for each of a plurality of brightness setting references,
wherein the classified brightness level information includes, respectively, a first illuminance condition for starting control of the brightness of the display and a second illuminance condition for ending control of the brightness of the display,
wherein the plurality of brightness setting references include a first brightness setting reference for automatically controlling the brightness of the display based on external illuminance, a second brightness setting reference for controlling the brightness of the display by fixing the brightness set by the user, and a third brightness setting reference for controlling the brightness of the display to be brighter than the brightness value set according to the second brightness setting reference.

4. The electronic device of claim 3, wherein the instructions, when executed by the at least one processor individually or collectively, cause the electronic device to: based on the set brightness control value being less than a current brightness value of the display or the temperature value of the electronic device being greater than or equal to a reference temperature level, change the brightness of the display to the set brightness control value, and based on the set brightness control value being greater than or equal to the current brightness value or the temperature value being less than the reference temperature level, maintain a current brightness of the display without changing the brightness of the display.

5. The electronic device of claim 3, wherein the instructions, when executed by the at least one processor individually or collectively, cause the electronic device to:
identify a brightness setting reference of the plurality of brightness setting references set for the display; and
based on the obtained illuminance value and the obtained temperature value, obtain the brightness setting value from the brightness level information corresponding to the identified brightness setting reference.

6. The electronic device of claim 3, wherein the instructions, when executed by the at least one processor individually or collectively, cause the electronic device to:
based on the obtained illuminance value satisfying the first illuminance condition, start a control of the brightness of the display; and
based on the obtained illuminance value satisfying the second illuminance condition, end the control of the brightness of the display.

7. The electronic device of claim 1, wherein the instructions, when executed by the at least one processor individually or collectively, cause the electronic device to:
display, on the display, a menu for receiving feedback information related to illuminance from the user; and
when receiving the feedback information using the menu, obtain the brightness setting value by applying the feedback information.

8. The electronic device of claim 1, wherein the instructions, when executed by the at least one processor individually or collectively, cause the electronic device to:
based on the obtained temperature value being greater than or equal to the threshold temperature value and the brightness setting value not existing, control the brightness of the display with a brightness control value obtained based on a surface temperature of the electronic device.

9. The electronic device of claim 8, wherein the instructions, when executed by the at least one processor individually or collectively, cause the electronic device to:
based on the obtained temperature value being less than the threshold temperature value, identify a temperature change amount of temperature values obtained over a specified period of time, and control the brightness of the display with a brightness control value obtained based on the identified temperature change amount.

10. A method of operating an electronic device, the method comprising:
obtaining a temperature value of the electronic device using at least one temperature sensor of the electronic device;
obtaining an illuminance value detected using at least one illuminance sensor of the electronic device;
based on the obtained temperature value being equal to or greater than a threshold temperature value, obtaining a brightness setting value corresponding to the obtained temperature value and the obtained illuminance value from brightness level information stored in memory of the electronic device;
setting a brightness control value with the obtained brightness setting value; and
based on the set brightness control value, controlling a brightness of a display of the electronic device.

11. The method of claim 10,
wherein the brightness level information is stored in the memory in the form of a table or a curve which includes a plurality of predetermined brightness setting values that correspond to a minimum brightness level that guarantees visibility for each of temperature levels and illuminance levels obtained through prior testing performed a specified number of times,
wherein the obtained brightness setting value is a value for identifying whether to change a previously set brightness control value based on a temperature change or illuminance change,
wherein the set brightness control value is set to a value less than or equal to a brightness level specified based on the temperature value of the electronic device to limit the brightness of the display, and
wherein the setting of the brightness control value comprises:
based on the obtained brightness setting value being different from the previously set brightness control value, identifying that the temperature change or the illuminance change occurs, and changing the previously set brightness control value to the obtained brightness setting value, and
based on the obtained brightness setting value being the same as the previously set brightness control value, identifying that the temperature change or the illuminance change has not occurred, and maintaining the previously set brightness control value which is the same as the obtained brightness setting value.

12. The method of claim 10,
wherein the brightness level information is classified for each of a plurality of brightness setting references,
wherein the classified brightness level information includes, respectively, a first illuminance condition for starting control of the brightness of the display and a second illuminance condition for ending control of the brightness of the display,
wherein the plurality of brightness setting references include a first brightness setting reference for automatically controlling the brightness of the display based on external illuminance, a second brightness setting reference for controlling the brightness of the display by fixing the brightness set by the user, and a third brightness setting reference for controlling the brightness of the display to be brighter than the brightness value set according to the second brightness setting reference.

13. The method of claim 12, wherein the controlling of the brightness of the display of the electronic device comprises:
based on the set brightness control value being less than a current brightness value of the display or the temperature value of the electronic device being greater than or equal to a reference temperature level, changing the brightness of the display to the set brightness control value, and
based on the set brightness control value being greater than or equal to the current brightness value or the temperature value being less than the reference temperature level, maintaining a current brightness of the display without changing the brightness of the display.

14. The method of claim 12, further comprising:
identifying a brightness setting reference of the plurality of brightness setting references set for the display.

15. The method of claim 14, wherein the obtaining of the brightness setting value comprises:
based on the obtained illuminance value and the obtained temperature value, obtaining the brightness setting value from the brightness level information corresponding to the identified brightness setting reference.

16. The method of claim 12, further comprising:
based on the obtained illuminance value satisfying the first illuminance condition, starting a control of the brightness of the display; and
based on the obtained illuminance value satisfying the second illuminance condition, ending the control of the brightness of the display.

17. The method of claim 10, further comprising:
displaying, on the display, a menu for receiving feedback information related to illuminance from the user; and
when receiving the feedback information using the menu, obtaining the brightness setting value by applying the feedback information.

18. The method of claim 10, further comprising:
based on the obtained temperature value being greater than or equal to the threshold temperature value and the brightness setting value not existing, controlling the brightness of the display with a brightness control value obtained based on a surface temperature of the electronic device.

19. The method of claim 18, further comprising:
based on the obtained temperature value being less than the threshold temperature value, identifying a temperature change amount of temperature values obtained over a specified period of time, and controlling the brightness of the display with a brightness control value obtained based on the identified temperature change amount.

20. One or more non-transitory computer-readable storage media storing one or more computer programs including computer-executable instructions that, when executed by one or more processors of an electronic device individually or collectively, cause the electronic device to perform operations, the operations comprising:
obtaining a temperature value of the electronic device using at least one temperature sensor of the electronic device;
obtaining an illuminance value detected using at least one illuminance sensor of the electronic device;
based on the obtained temperature value being equal to or greater than a threshold temperature value, obtaining a brightness setting value corresponding to the obtained temperature value and the obtained illuminance value from brightness level information stored in memory of the electronic device;
setting a brightness control value with the obtained brightness setting value; and
based on the set brightness control value, controlling a brightness of a display of the electronic device.
